(19) United States
(12) Patent Application Publication
(10) Pub. No.: US 2021/0219761 A1
(43) Pub. Date: Jul. 22, 2021

(54) Beverage Heater

(71) Applicants: Mark Goodson, Corinth, TX (US); Christian Ross Goodson, Corinth, TX (US)

(72) Inventors: Mark Goodson, Corinth, TX (US); Christian Ross Goodson, Corinth, TX (US)

(21) Appl. No.: 17/165,589

(22) Filed: Feb. 2, 2021

Related U.S. Application Data
(63) Continuation-in-part of application No. 15/887,752, filed on Feb. 2, 2018, now Pat. No. 10,905,268.
Application No. 15/887,752 is a continuation-in-part of application No. 15/218,442, filed on Jul. 25, 2016, now Pat. No. 10,667,637.
(60) Provisional application No. 62/282,165, filed on Jul. 28, 2015.

(51) Int. Cl. A47G 23/03; H05B 1/02

(52) U.S. Cl. CPC A47G 23/0313; F25D 31/008; H05B 1/0252

(57) ABSTRACT

A system having a beverage coaster with a receiving coil that can be magnetically coupled or decoupled from a driving coil in a counter, table, bar, and the like. The coaster may be magnetically coupled to the table by moving the coaster into an area where the driving coil generates a magnetic field of sufficient strength. The coaster also includes a switch that activated or deactivated based on its proximity to a magnet in the table. The coaster has a metallic plate on which may be positioned a beverage container. The plate is thermally and mechanically coupled to a Peltier cell or resistance heater that either cools or heats the plate, depending on the state of the switch. A second magnetic switch powers the driving coil only if the coaster is present and aligned with the driving coil.

### CROSS REFERENCE TO RELATED APPLICATIONS

This application claims the benefit of and priority to U.S. non-provisional application Ser. No. 15/887,752, filed Feb. 2, 2018 and issued as U.S. Pat. No. 10,905,268, entitled “Beverage Cooler and Heater” which claims benefit to U.S. non-provisional application Ser. No. 15/218,442, filed Jul. 25, 2015 and issued as U.S. Pat. No. 10,667,637, entitled “Beverage Cooler and Heater” which claimed benefit to U.S. provisional application Ser. No. 62/282,165, filed Jul. 28, 2015, entitled “Serving Table With Inset Beverage Cooling.” The three above applications are incorporated by reference.

### STATEMENT REGARDING FEDERALLY SPONSORED RESEARCH OR DEVELOPMENT

Not Applicable

### BACKGROUND OF THE INVENTION

### 1. Field of the Invention

The present invention generally applies to temperature control of a liquid. More specifically, the present invention relates to temperature heating of an already served beverage.

### 2. Description of the Related Art

Drinks that are served in a restaurant are usually cooled or heated, with many beverages being cooled by ice. Some drinks, such as coffee and cocoa, are enjoyed while being served hot or warm. The laws of heat transfer mandate that over time thermal gain or loss of the beverage will continue until the beverage reaches room temperature (thermal equilibria). Drinks that are cold will usually have ice melt due to heat gain, while drinks served warm or hot will have a heat loss and thus they cool off.

Some issued patents make use of heating and cooling of a glass, cup or similar vessel. Senecal (U.S. Pat. No. 5,718,124), for example, teaches the refrigeration of a service bowl, with the refrigeration circuitry being part of the bowl. Similarly, Alexander (U.S. Pat. Nos. 8,759,721 and 9,035,222) teach the use of heated or cooled beverage holders where the circuitry that is providing the temperature change is part of the glassware or serving dishes. Simcray (U.S. Pat. No. 6,279,470) teaches the use of vessel that has an armature as part of the plate or food holder. Simcray, however, does not teach the use of a coaster that can accommodate various cooking vessels that may already be owned by the user.

Additional publications, such as U.S. Pat. Publication 2010/0072191 and Japanese Application 2007-064557, teach harnessing magnetic energy from an induction cooktop or stove for cooling purposes only. In these publications, the magnetic coils have differing sizes causing the energy transfer to be inefficient. Furthermore, the large transmitting area of a magnetic field that is on a cooktop results magnetic flux that is not intercepted by the receiving coil. This excess flux can generate eddy currents in nearby ferrous parts, causing overheating The Japanese Application 2007-064557 discloses its own container or vessel, which offers less utility than a coaster which can be used with multiple vessels. Finally, none of these publications teach or suggest a presence sensor which only allows powering of the transmitting coils if a receiving coil is present.

### BRIEF SUMMARY OF THE INVENTION

The present invention provides a number of advantages over existing art. For example, the present invention allows the heating of a beverage holder (e.g., a cup or glass) without the necessity of that beverage holder containing any circuitry or specially designed components. Moreover, the present invention allows for variable heating of the beverage holder to be selected without the use of any manually operated switch; instead, a change of alignment of the coaster will allow the heating mode to turned off or put the coaster into the desired heating mode. The present invention also provides a presence indicator switch that prevents an energized table surface if the heating of the coaster is not needed at a particular moment.

Structurally, the present invention comprises a beverage coaster having a first end, an opposing second end, a housing, a non-corrosive metallic plate connected to the housing at the first end, a Peltier cell, or resistance heater, within the housing mechanically and thermally connected to the metallic plate, a switch within the housing, a receiving coil located within the housing proximal to the second end, and coaster circuitry electrically connected to the Peltier cell ore resistance heater, the switch, and the receiving coil; and a counter or table with a top surface and a bottom surface, a magnet, a driving coil, and driver circuitry connected to the driving coil. A second magnetic switch is placed in series with the power supply of the table-embedded driving coil, and a corresponding magnet is mounted in the coaster and allows the transmitting coil to be powered when the coaster is present.

### BRIEF DESCRIPTION OF THE DRAWINGS

FIG. 1 shows a first embodiment of the present invention.

FIG. 2 is a schematic of the coaster circuitry of the first embodiment in a “heating” configuration.

FIG. 3 is a schematic of the driver circuitry of the first embodiment.

FIG. 4 shows the reed switch of the first embodiment coaster misaligned with the magnet of the countertop.

FIG. 5 is a schematic of the coaster circuitry of the first embodiment in a “cooling” configuration.

FIG. 6 shows a second embodiment of the present invention.

FIG. 7 is a schematic of the coaster circuitry of the second embodiment in a high heat configuration.

FIG. 8 is a schematic of the driver circuitry of the second embodiment.

FIG. 9 is a schematic of the coaster circuitry of the second embodiment in a high heat configuration with the first thermostat open.

FIG. 10 shows the reed switch of the second embodiment coaster misaligned with the magnet of the countertop.

FIG. 11 is a schematic of the coaster circuitry of the second embodiment in a low heat configuration.

FIG. 12 shows a third embodiment of the present invention.

FIG. 13 is a schematic of the coaster circuitry of the third embodiment in a high heat configuration.

FIG. 14 is a schematic of the driver circuitry of the third embodiment.

FIG. 15 is a schematic of the coaster circuitry of the third embodiment in a high heat configuration with the first thermostat open.

FIG. 16 shows the reed switch of the third embodiment coaster misaligned with the magnet of the countertop.

FIG. 17 is a schematic of the coaster circuitry of the third embodiment in a low heat configuration.

FIG. 18 is a top view of the countertop of the third embodiment shown with two coasters.

### DESCRIPTION OF SPECIFIC EMBODIMENTS

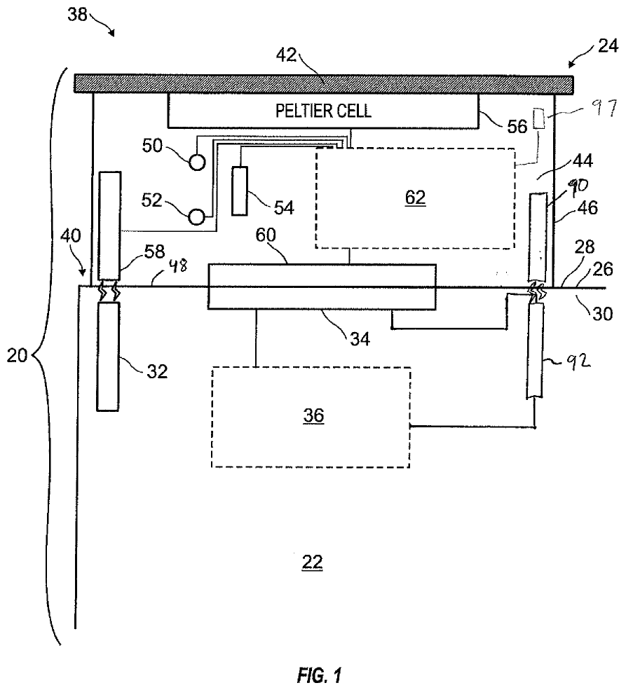

FIG. 1 shows a first embodiment 20 of the invention, which includes a counter 22 and a beverage coaster 24. The counter 22 includes a countertop 26 with a top surface 28 and a bottom surface 30, a rod magnet 32, an inductive driving coil 34, and driver circuitry 36 electrically connected to the inductive driving coil 34. A reed switch 92 is placed in series between the driver circuitry 36 and the inductive driving coil 34. The rod magnet 32, inductive driving coil 34, reed switch 92 and driver circuitry 36 are adjacent to the bottom surface 30 of the countertop 26. While this embodiment 20 contemplates the inductive driving coil 34 and driver circuitry 36 being adjacent the countertop, alternatively, they can be inset as part of the countertop 26. Although this embodiment 20 is described specifically with reference to a countertop, other embodiments contemplate the invention include a table, bar top, and the like.

The coaster 24 is generally a closed cylinder with a first end 38 and a second end 40. The second end 40 contacts the countertop 26 opposite the driver circuitry 36. The coaster 24 is made of a solid cylindrical copper plate 42 attached to a hollow cylindrical plastic housing 44 with a sidewall 46 and a closed end 48 coterminal with the second end 40. A red LED 50, a blue LED 52, a USB port 54, and a control 97 are mounted to the sidewall 46. Copper is preferred because of its resistance to corrosion and for its coefficient of thermal conductivity, but other metals may be used. A rod magnet 90 is located at the second end of closed end 48.

The housing 44 encloses a Peltier cell 56 (sometimes called a Peltier device, Peltier heat pump, solid state refrigerator, or thermoelectric cooler (TEC)), a reed switch 58, a receiving coil 60, and coaster circuitry 62. The Peltier cell 56 is mechanically and thermally connected to the copper plate 42. The thermal connection is enhanced with the use of thermally conducting grease (not shown) between the Peltier cell 56 and the copper plate 42. The reed switch 58 is adjacent to the sidewall 46 of the housing 44 and is aligned with, and magnetically coupled to, the magnet 32. The receiving coil 60 is located proximal to the closed end 48 and is vertically aligned with the driving coil 34. The coaster circuitry 62 electrically connects the LEDs 50, 52, the USB port 54, the Peltier cell 56, and the reed switch 58. The reed switch 92 is adjacent to the sidewall 46 of the housing 44 and is aligned with, and magnetically coupled to, the magnet 90.

Referring to FIG. 2, the coaster circuitry 62 includes an AC-to-DC converter 64 connected to the receiving coil 60, a voltage regulator 66 connected to the USB port 54, a relay coil 67 connected to the reed switch 58, a first pair of relay contacts 68, a second set of relay contacts 70, and a pair of relay armatures 72. The regulator 66 is a standard 3-lead 5-volt regulator that provides power to the USB port 54, allowing the coaster 24 to also serve as a means for charging a phone or operating a game. A thermostat 96, having a sensor 102, is electrically in series with the power lead to the Peltier cell 56. The thermostat may be set by a control 97 accessible on the sidewall 46. The control 97 sets the thermostat 96 to a desired temperature or to a setting of low or high. The sensor 102 is mounted to copper plate 42. In the preferred embodiment the sensor 102 and thermostat 96 may be mechanical, or bimetal switch. The thermostat 96 allows current to the Peltier cell to be temporarily be removed should a desirable drink temperature be measured. In a preferred embodiment, the inductive driving coil 34 and the receiving coil 60 are tuned to the same frequency to maximize efficiency. In a further preferred embodiment, the inductive driving coil 34 and the receiving coil 60 have approximately the same diameter. In a preferred embodiment, the inductive driving coil 34 and the receiving coil 60 have a diameter of approximately two inches.

In FIG. 2, the reed switch 58 and armatures 72 are in the state corresponding to the position of the coaster 24 shown in FIG. 1, with the reed switch 58 aligned with the magnet 32. The reed switch 58 is closed and the armatures 72 are in contact with the first pair of contacts 68. This configuration causes the Peltier cell 56 to generate heat at the connection with the copper plate 42. The red LED 50 is in parallel with the input of the Peltier cell 56 and will be energized in this configuration when the receiving coil 60 is energized and the reed switch 58 is closed. The blue LED 52 is energized whenever the receiving coil is energized, regardless of the state of the reed switch 58.

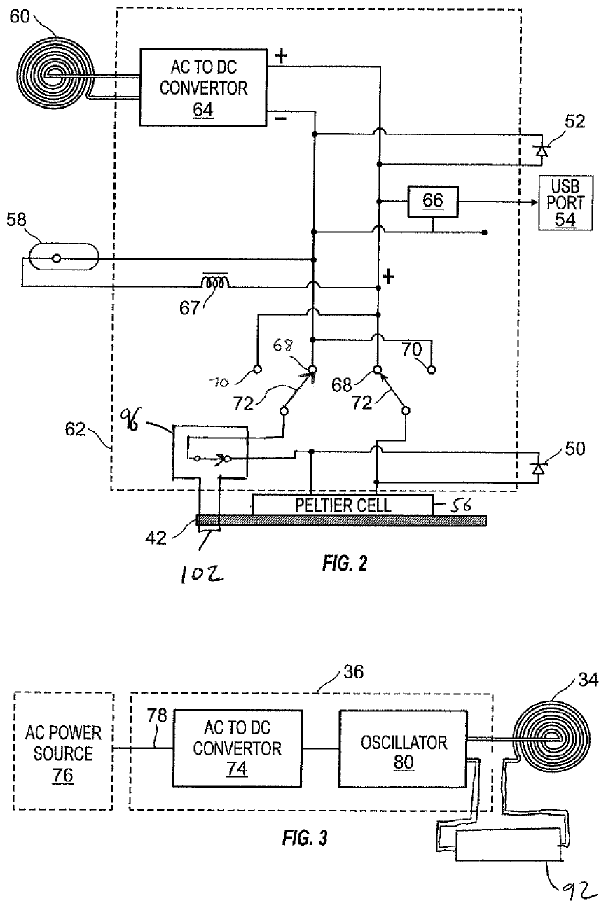

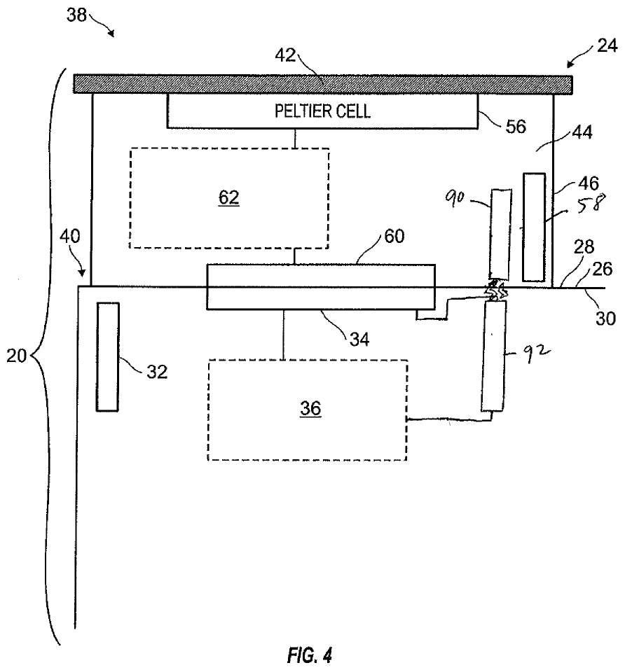

Referring to FIG. 3, the driver circuitry 36 includes an AC-to-DC converter 74 connectable to an AC input source 76 (nominal 120 VAC 60 Hz) with a line cord 78. The converter 74 rectifies and filters the signal from the input source 76. The output of the converter 74 is connected to a 10 KHz oscillator 80 that generates a square wave. The output of the oscillator 80 is connected to the driving coil 34 and passes through reed switch 92. The reed switch 92 must be closed in order for the driving coil 34 to be energized. When a coaster is not in use for cooling or heating, the coaster is rotated or moved in such a manner that the magnet 90 is not positioned over the reed switch 92. The driver circuitry 36 is enclosed so it is protected from mechanical damage (e.g., spills, mechanical cuts from serving utensils).

Referring to FIG. 4, the coaster 24 is rotated relative to its position in FIG. 1 so the reed switch 58 is not aligned with the rod magnet 32. However, the reed switch 92 remains aligned with the magnet 90.

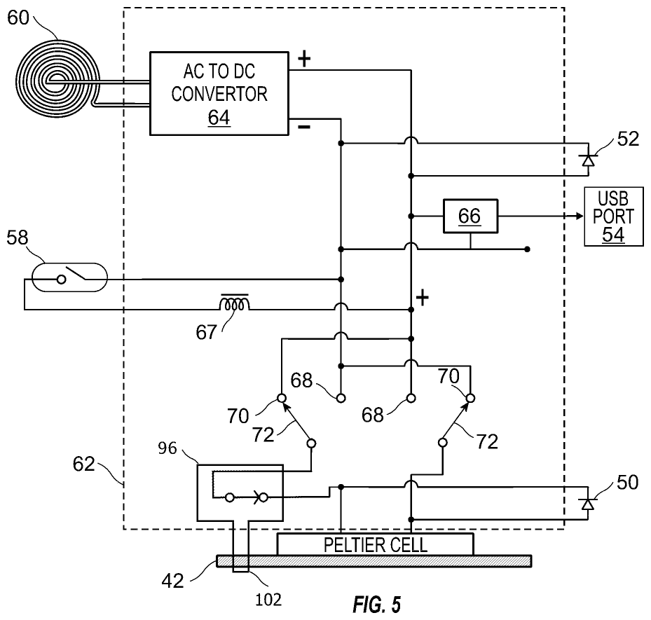

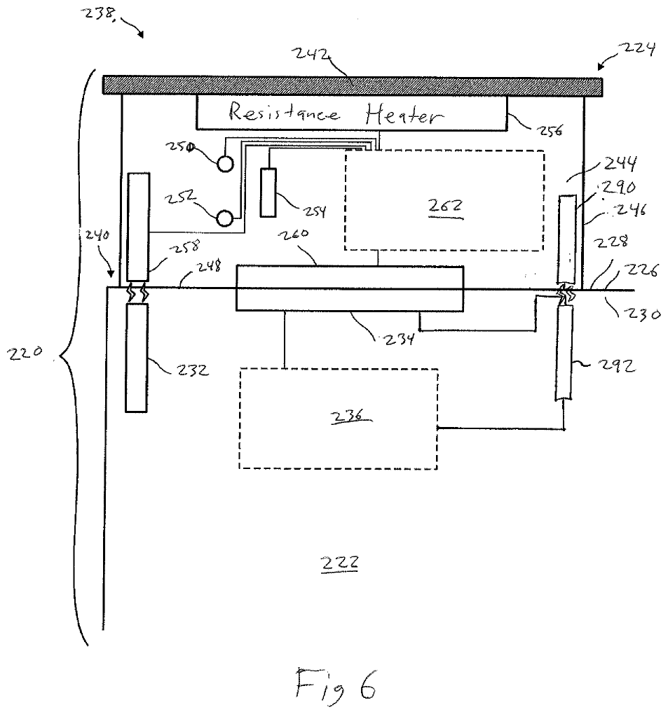

Referring to FIG. 5, corresponding to the position of the coaster 24 shown in FIG. 4, when the reed switch 58 is not aligned with the magnet 32, the reed switch 58 is open. This causes the armatures 72 to be in their normal position of contact with the second set of contacts 70. This configuration causes the Peltier cell 56 to cool at its connection with the copper plate 42. Only the blue LED 52 is energized in this configuration, indicating magnetic coupling (and resultant energy transfer) between the driving coil 34 (see FIG. 3) and the receiving coil 60 in the coaster 24.

In order to provide heating to the copper plate, the coaster 42 must be positioned in such a manner that the magnet 90 and the reed switch 58 of the coaster 42 are aligned with the reed switch 92 and the magnet 32 of the counter 22. In order to provide cooling to the copper plate, the coaster 42 must be positioned in such a manner that the magnet 90 of the coaster 42 is aligned with the reed switch 92 but positioned in such a manner that the reed switch 58 is not aligned with the magnet 32 of the counter 22. To ensure the surface of the counter 22 is not energized, i.e. the driving coil 34, the magnet 90 of the coaster 42 should not be aligned with the reed switch 92 of the counter 22. If the desired temperature is measured, as measured by the sensor 102 and equals the set point of the thermostat 96, the circuit is opened and prevents further current from flowing into the Peltier cell 56.

FIGS. 6-11 show a second embodiment of the present invention. Referring to FIGS. 6 and 8, this embodiment includes a counter 222 and a beverage coaster 224. The counter 222 includes a countertop 226 with a top surface 228 and a bottom surface 230, a rod magnet 232, an inductive driving coil 234, and driver circuitry 236 electrically connected to the inductive driving coil 234. A reed switch 292 is placed in series between the driver circuitry 236 and the inductive driving coil 234. The rod magnet 232, inductive driving coil 234, reed switch 292 and driver circuitry 236 are adjacent to the bottom surface 230 of the countertop 226. While this embodiment 220 contemplates the inductive driving coil 234 and driver circuitry 236 being adjacent the countertop 226, alternatively, they can be inset as part of the countertop 226. Although this embodiment 220 is described specifically with reference to a countertop, other embodiments contemplate the invention include a table, bar top, and the like.

The coaster 224 is generally a closed cylinder with a first end 238 and a second end 240. The second end 240 contacts the countertop 226 opposite the driver circuitry 236. The coaster 224 is made of a solid cylindrical copper plate 242 attached to a hollow cylindrical plastic housing 244 with a sidewall 246 and a closed end 248 coterminal with the second end 240. A red LED 250, a blue LED 252, and a USB port 254 are mounted to the sidewall 246. Copper is preferred because of its resistance to corrosion and for its coefficient of thermal conductivity, but other metals may be used. A rod magnet 290 is located at the second end of closed end 248.

The housing 244 encloses a resistance heater 256, a reed switch 258, a receiving coil 260, and coaster circuitry 262. The resistance heater 256 is mechanically and thermally connected to the copper plate 242. The thermal connection is enhanced with the use of thermally conducting grease (not shown) between the resistance heater 256 and the copper plate 242. The reed switch 258 is adjacent to the sidewall 246 of the housing 244 and is aligned with, and magnetically coupled to, the magnet 232. The receiving coil 260 is located proximal to the closed end 248 and is vertically aligned with the driving coil 234. The coaster circuitry 262 electrically connects the LEDs 250, 252, the USB port 254, the resistance heater 256, and the reed switch 258. The magnet 290 is adjacent to the sidewall 246 of the housing 244 and is aligned with, and magnetically coupled to the reed switch 292

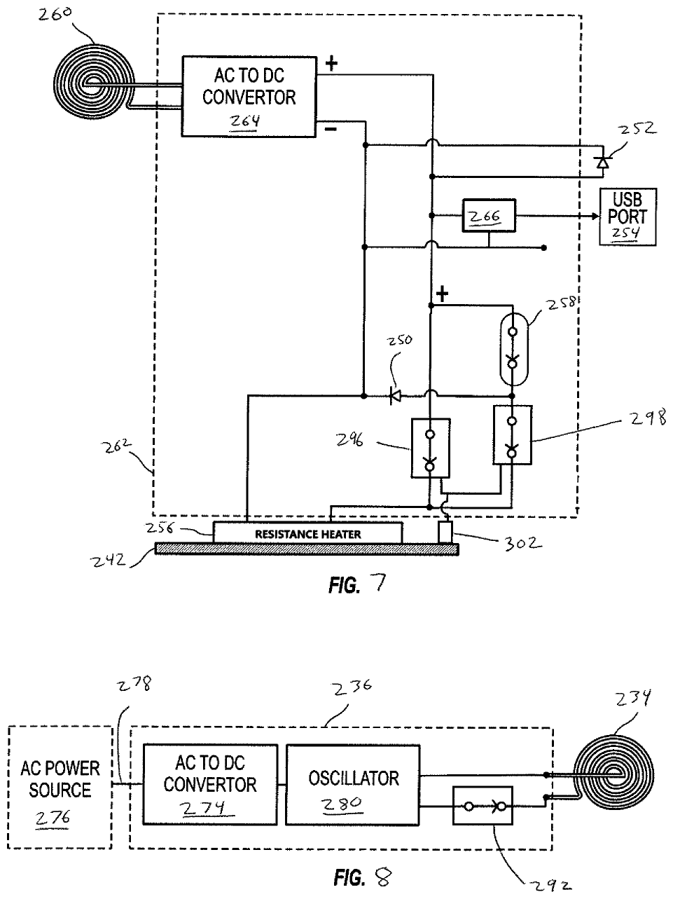

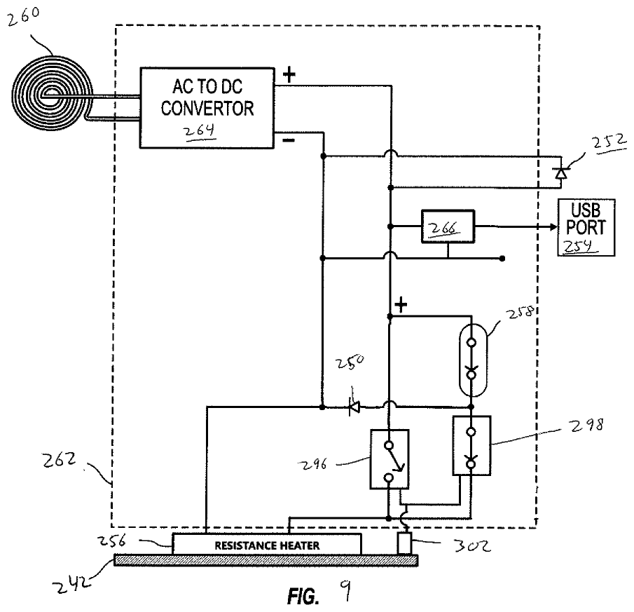

Referring to FIG. 7, the coaster circuitry 262 includes an AC-to-DC converter 264 connected to the receiving coil 260, a voltage regulator 266 connected to the USB port 254, first thermostat 296, and second thermostat 298 in series with a reed switch 258. The regulator 266 is a standard 3-lead 5-volt regulator that provides power to the USB port 254, allowing the coaster 224 to also serve as a means for charging a phone or operating a game. In a further preferred embodiment, the inductive driving coil 34 and the receiving coil 60 have approximately the same diameter. In a preferred embodiment, the inductive driving coil 34 and the receiving coil 60 have a diameter of approximately two inches. In a preferred embodiment, the inductive driving coil 34 and the receiving coil 60 are tuned to the same frequency to maximize efficiency.

The first thermostat 296, in communication with a sensor 302, is electrically in series with the resistance heater 256. The first thermostat 296 allows the current to the resistance heater 256 to be temporarily removed if the set temperature, as measured by the sensor 302, is measured. In one embodiment, the temperature of the first thermostat may be set at 120 degrees Fahrenheit. The second thermostat 298, in communication with a sensor 302, and a red light 250 are parallel to the first thermostat 296. The reed switch 258 controls whether current is supplied to the second thermostat 298 and red LED 250. The second thermostat 298 allows current to be temporarily removed if the set temperature, as measured by the sensor 302, is measured. In the preferred embodiment, the temperature of the second thermostat 298 may be set at 140 degrees Fahrenheit. The sensor 302 is mounted to copper plate 42. In the preferred embodiment the sensor 302, first thermostat 296, and second thermostat 298 may be mechanical, or bimetal switch.

Referring to FIG. 8, the driver circuitry 36 includes an AC-to-DC converter 274 connectable to an AC input source 276 (nominal 120 VAC 60 Hz) with a line cord 278. The converter 274 rectifies and filters the signal from the input source 276. The output of the converter 274 is connected to a 10 KHz oscillator 80 that generates a square wave. The output of the oscillator 280 is connected to the driving coil 234 and passes through reed switch 292. The reed switch 292 must be closed in order for the driving coil 234 to be energized. When a coaster is not in use for heating, the coaster is rotated or moved in such a manner that the magnet 290 is not positioned over the reed switch 292. The driver circuitry 236 is enclosed so it is protected from mechanical damage (e.g., spills, mechanical cuts from serving utensils).

In FIG. 7, the reed switch 258 and reed switch 292 are in the state corresponding to the position of the coaster 224 shown in FIG. 6, with the reed switch 258 aligned with the magnet 232 and magnet 290 aligned with reed switch 292. The reed switch 292 is closed allowing driving coil 234 to be energized. The reed switch 258 is closed which allows current to flow through both the first thermostat 296 and second thermostat 298. This configuration causes the resistance heater 256 to generate heat at the connection with the copper plate 242. The red LED 250 is energized in this configuration when the receiving coil 260 is energized, the reed switch 258 is closed, and the second thermostat 298 is closed. The blue LED 252 is energized whenever the receiving coil is energized, regardless of the state of the reed switch 258. As seen in FIG. 7, the temperature as measured by sensor 302 has not exceeded the set temperature of the first thermostat 296 thus current may continue to pass through the first thermostat 296, second thermostat 298, and red LED 250. As seen in FIG. 9, when the temperature as measured by sensor 302 exceeds the set temperature of the first thermostat 296, current is no longer able to flow through the first thermostat 296. However, current may continue to flow through the second thermostat 298 until the set temperature of the second thermostat 298 is measured. If the sensor 302 records a temperature higher than the set temperature of the second thermostat 298, then the second thermostat 298 temporarily cuts off current which then prevents any current from flowing into the resistance heater 256. Even if the first thermostat 296 and second thermostat 298 cut off current, the blue LED 252 and USB port 254 remain energized.

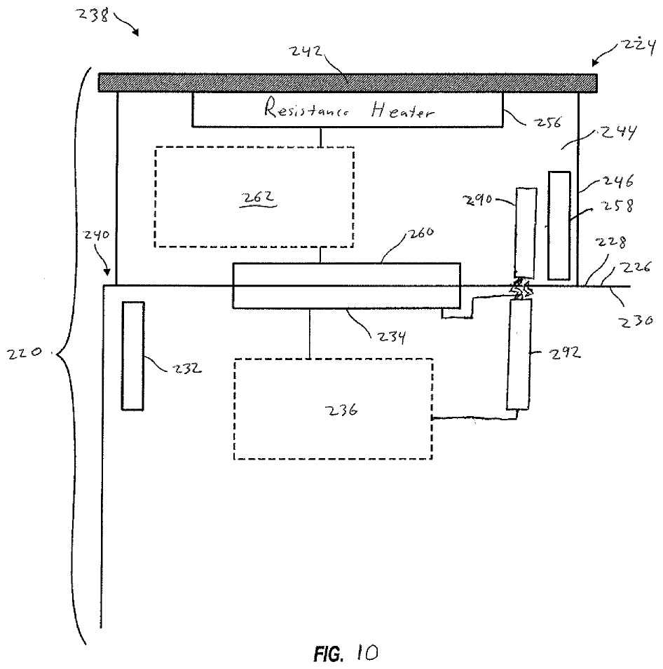

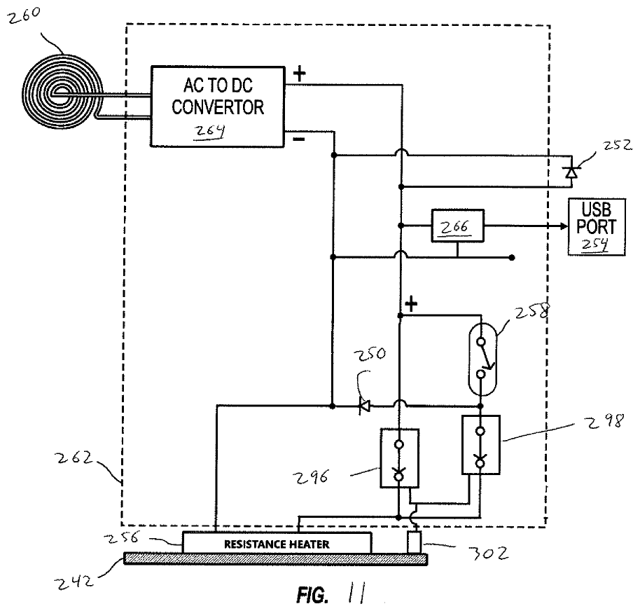

Referring to FIG. 10, the coaster 224 is rotated relative to its position in FIG. 6 so the reed switch 258 is not aligned with the rod magnet 232. However, the reed switch 292 remains aligned with the magnet 290.

Referring to FIG. 11, corresponding to the position of the coaster 224 shown in FIG. 10, when the reed switch 258 is not aligned with the magnet 232, the reed switch 258 is open. This prevents current from flowing into the second thermostat 298 and the red LED 250. This configuration permits the resistance heater 256 to heat the copper plate 242 until the sensor 302 records the set temperature of the first thermostat 296. If the set temperature of the first thermostat 296 is measured, the first thermostat 296 temporarily cuts off current to the resistance heater 256. Once the sensor 302 records a temperature below the set point of the first thermostat 296, the current will then be restored allowing the resistance heater 256 to heat the copper plate 242. Only the blue LED 252 is energized in this configuration, indicating magnetic coupling (and resultant energy transfer) between the driving coil 234 (see FIG. 8) and the receiving coil 260 in the coaster 224.

To ensure the surface of the counter 222 is not energized, i.e. the driving coil 234, the magnet 290 of the coaster 242 should not be aligned with the reed switch 292 of the counter 222. To position the coaster 242 to have the highest heat setting, i.e. the set temperature of the second thermostat 298, the reed switch 258 must be closed by aligning the reed switch 258 with the magnet 232. To position the coaster 242 to have the lowest heat setting, the coaster must be positioned such that the magnet 290 is aligned with the reed switch 292 but that the reed switch 258 is not aligned with the magnet 232. This embodiment allows a user to choose three settings by the position of the coaster 242 relative to the counter 222: off, low heat, and high heat. Additional combinations of magnets and reed switches used in conjunction with thermostats, may create more than two heat settings depending on position of the coaster 242 relative to the counter 222.

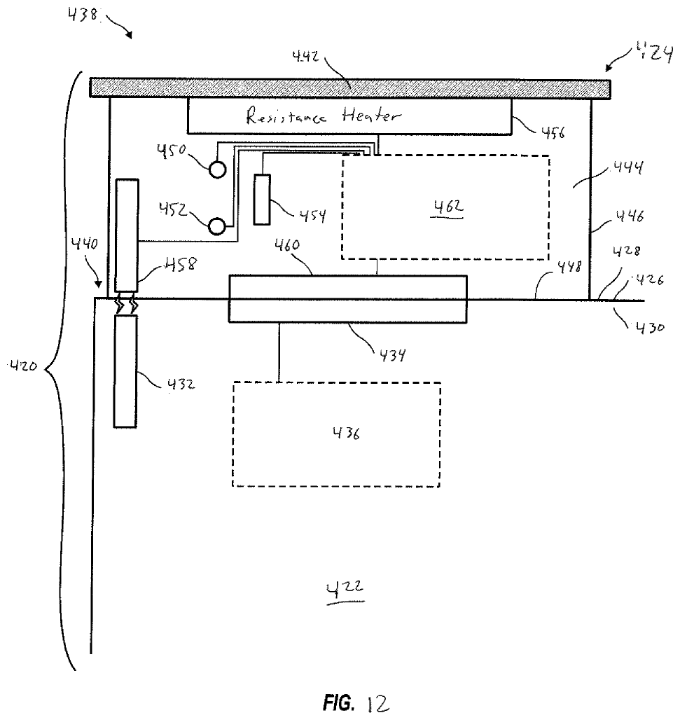

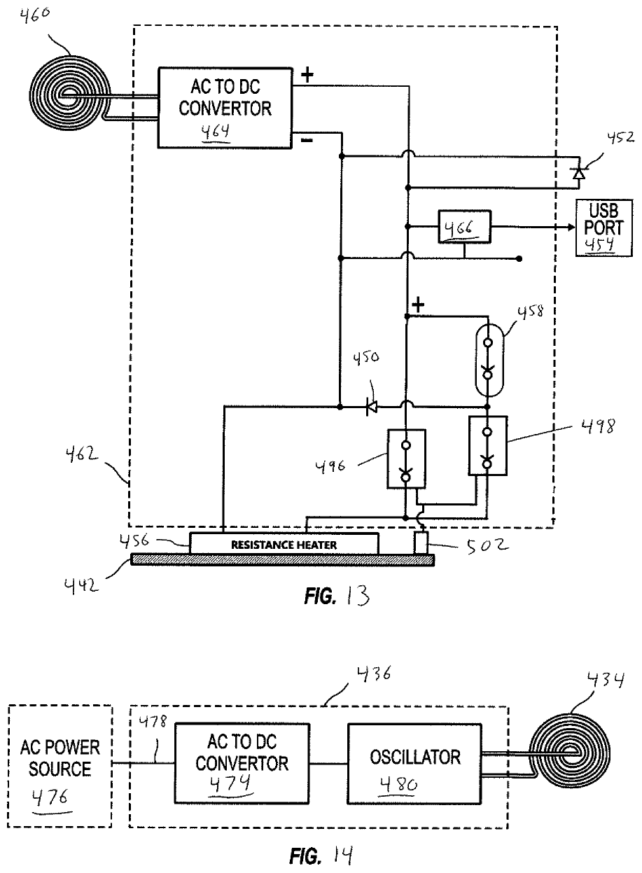

FIGS. 12-18 show a third embodiment of the present invention. Referring to FIGS. 12 and 14, this embodiment includes a counter 422 and a beverage coaster 424. The counter 422 includes a countertop 426 with a top surface 428 and a bottom surface 430, a rod magnet 432, an inductive driving coil 434, and driver circuitry 436 electrically connected to the inductive driving coil 434. The rod magnet 432, inductive driving coil 434, and driver circuitry 436 are adjacent to the bottom surface 430 of the countertop 426. While this embodiment 420 contemplates the inductive driving coil 434 and driver circuitry 436 being adjacent the countertop 426, alternatively, they can be inset as part of the countertop 426. Although this embodiment 420 is described specifically with reference to a countertop, other embodiments contemplate the invention include a table, bar top, and the like.

The coaster 424 is generally a closed cylinder with a first end 438 and a second end 440. The second end 440 contacts the countertop 426 opposite the driver circuitry 436. The coaster 424 is made of a solid cylindrical copper plate 442 attached to a hollow cylindrical plastic housing 444 with a sidewall 446 and a closed end 448 coterminal with the second end 440. A red LED 450, a blue LED 452, and a USB port 454 are mounted to the sidewall 446. Copper is preferred because of its resistance to corrosion and for its coefficient of thermal conductivity, but other metals may be used.

The housing 444 encloses a resistance heater 456, a reed switch 458, a receiving coil 460, and coaster circuitry 462. The resistance heater 456 is mechanically and thermally connected to the copper plate 442. The thermal connection is enhanced with the use of thermally conducting grease (not shown) between the resistance heater 456 and the copper plate 442. The reed switch 458 is adjacent to the sidewall 446 of the housing 444 and is aligned with, and magnetically coupled to, the magnet 432. The receiving coil 460 is located proximal to the closed end 448 and is vertically aligned with the driving coil 434. The coaster circuitry 462 electrically connects the LEDs 450, 452, the USB port 454, the resistance heater 456, and the reed switch 458.

Referring to FIG. 13, the coaster circuitry 462 includes an AC-to-DC converter 464 connected to the receiving coil 460, a voltage regulator 466 connected to the USB port 454, first thermostat 496, and second thermostat 498 in series with the reed switch 458. The regulator 466 is a standard 3-lead 5-volt regulator that provides power to the USB port 454, allowing the coaster 424 to also serve as a means for charging a phone or operating a game. In a further preferred embodiment, the inductive driving coil 434 and the receiving coil 460 have approximately the same diameter. In a preferred embodiment, the inductive driving coil 434 and the receiving coil 460 have a diameter of approximately two inches. In a preferred embodiment, the inductive driving coil 434 and the receiving coil 460 are tuned to the same frequency to maximize efficiency.

The first thermostat 496, in communication with a sensor 502, is electrically in series with the resistance heater 456. The first thermostat 496 allows the current to the resistance heater 456 to be temporarily removed if the set temperature, as measured by the sensor 502, is measured. In one embodiment, the temperature of the first thermostat 496 may be set at 120 degrees Fahrenheit. The second thermostat 498, in communication with a sensor 502, and a red light 450 are parallel to the first thermostat 496. The reed switch 458 controls whether current is supplied to the second thermostat 498 and red LED 450. The second thermostat 498 allows current to be temporarily removed if the set temperature, as measured by the sensor 502, is measured. In the preferred embodiment, the temperature of the second thermostat 498 may be set at 140 degrees Fahrenheit. The sensor 502 is mounted to copper plate 442. In the preferred embodiment the sensor 502, first thermostat 496, and second thermostat 498 may be mechanical, or bimetal switch.

Referring to FIG. 14, the driver circuitry 436 includes an AC-to-DC converter 474 connectable to an AC input source 476 (nominal 120 VAC 60 Hz) with a line cord 478. The converter 474 rectifies and filters the signal from the input source 476. The output of the converter 474 is connected to a 10 KHz oscillator 480 that generates a square wave. The output of the oscillator 480 is connected to the driving coil 434. The driver circuitry 436 is enclosed so it is protected from mechanical damage (e.g., spills, mechanical cuts from serving utensils).

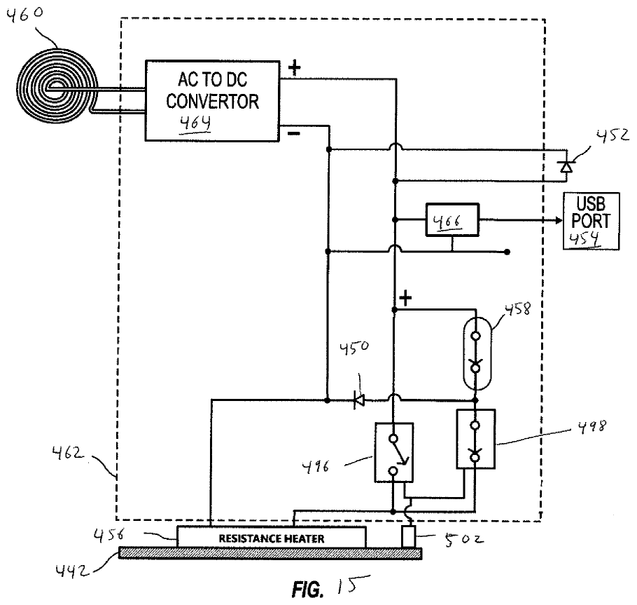

In FIG. 13, the reed switch 458 is in the state corresponding to the position of the coaster 424 shown in FIG. 12, with the reed switch 458 aligned with the magnet 432. The reed switch 458 is closed which allows current to flow through both the first thermostat 496 and second thermostat 498. This configuration causes the resistance heater 456 to generate heat at the connection with the copper plate 442. The red LED 450 is energized in this configuration when the receiving coil 460 is energized, the reed switch 458 is closed, and the second thermostat 498 is closed. The blue LED 452 is energized whenever the receiving coil is energized, regardless of the state of the reed switch 458. As seen in FIG. 13, the temperature as measured by sensor 502 has not exceeded the set temperature of the first thermostat 496 thus current may continue to pass through the first thermostat 496, second thermostat 498, and red LED 450. As seen in FIG. 15, when the temperature as measured by sensor 502 exceeds the set temperature of the first thermostat 496, current is no longer able to flow through the first thermostat 496. However, current may continue to flow through the second thermostat 498 until the set temperature of the second thermostat 498 is measured. If the sensor 502 records a temperature higher than the set temperature of the second thermostat 498, then the second thermostat 498 temporarily cuts off current which then prevents any current from flowing into the resistance heater 456. Even if the first thermostat 496 and second thermostat 498 cut off current, the blue LED 452 and USB port 454 remain energized.

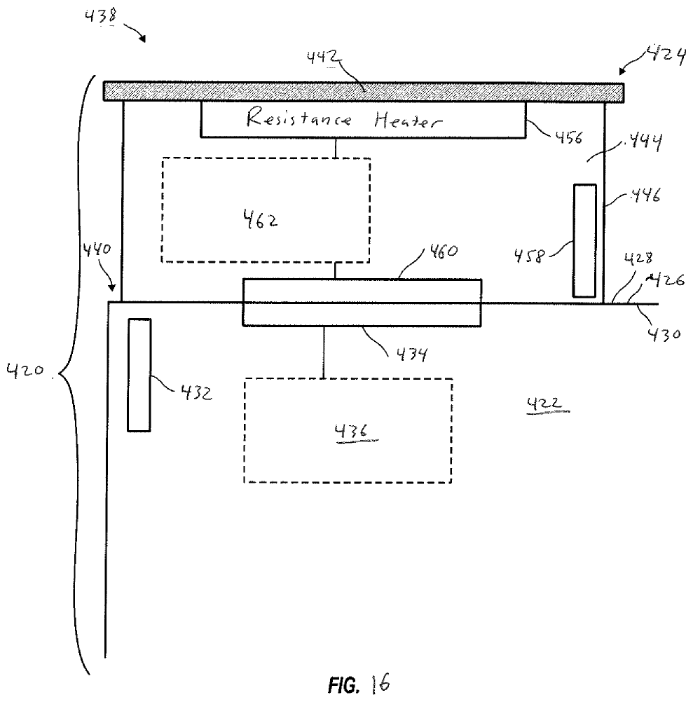

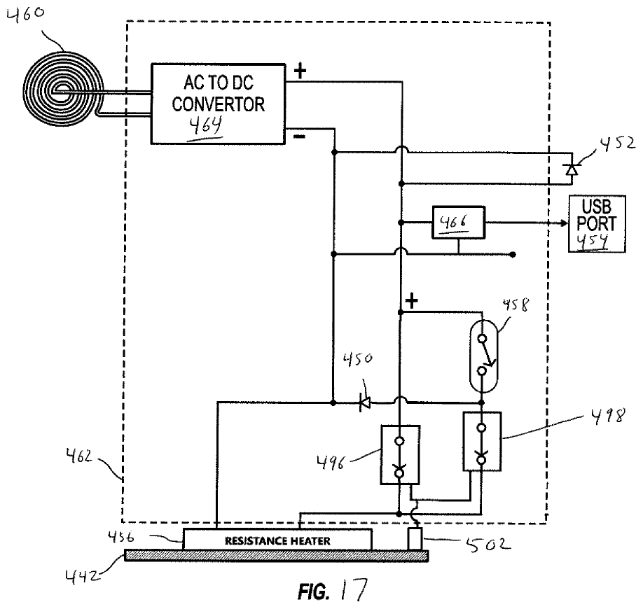

Referring to FIG. 16, the coaster 424 is rotated relative to its position in FIG. 12 so the reed switch 458 is not aligned with the rod magnet 432.

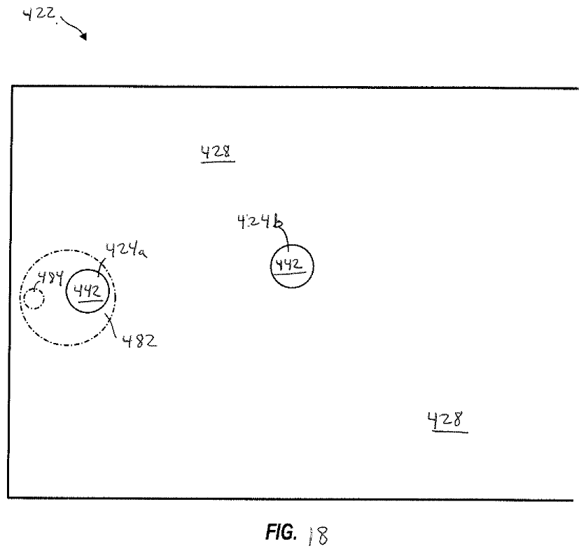

Referring to FIG. 17, corresponding to the position of the coaster 424 shown in FIG. 16, when the reed switch 458 is not aligned with the magnet 432, the reed switch 458 is open. This prevents current from flowing into the second thermostat 498 and the red LED 450. This configuration permits the resistance heater 456 to heat the copper plate 442 until the sensor 502 records the set temperature of the first thermostat 496. If the set temperature of the first thermostat 496 is measured, the first thermostat 496 temporarily cuts off current to the resistance heater 456. Once the sensor 402 records a temperature below the set point of the first thermostat 496, the current will then be restored allowing the resistance heater 456 to heat the copper plate 442. Only the blue LED 452 is energized in this configuration, indicating magnetic coupling (and resultant energy transfer) between the driving coil 434 (see FIG. 14) and the receiving coil 460 in the coaster 424.

Referring to FIG. 18, when powered, the driver circuitry 436 (not shown) generates a magnetic field that intersects an area 482 of the top surface 428 in which coasters 424a, 424b will be energized when in contact with the top surface 428. To position the coaster 442 to have the highest heat setting, i.e. the set temperature of the second thermostat 298, the reed switch 458 must be closed by aligning the reed switch 458 with the magnet 432. To position the coaster 442 to have the lowest heat setting, the coaster 442 must be positioned such that the reed switch 458 is not aligned with the magnet 432. In references to FIG. 18, the reed switch 458 (not shown) of the coasters 424a, 424b, however, must be within a smaller area 484 above the magnet 432 (not shown) to close the reed switch 458 and cause the resistance heater 456 to heat the copper plate 442 to the highest temperature as described with reference to FIGS. 12, 13, and 15. In FIG. 18, coaster 24a is energized and coaster 24b is not energized.

The present invention is described in terms of a specifically described embodiment. Those skilled in the art will recognize that other embodiments of such method and system can be used in carrying out the present invention. Other aspects and advantages of the present invention may be obtained from a study of this disclosure and the drawings, along with the appended claims.

We claim:

1. A beverage heating system comprising:
a beverage coaster having a first end, an opposing second end, a housing, a metallic plate connected to the housing at the first end, a resistance heater within the housing mechanically and thermally connected to the metallic plate, a first switch within the housing having a first position that results in heating the metallic plate in a low setting and a second position and that results in heating the metallic plate in a high setting, a receiving coil located within the housing proximal to the second end, and coaster circuitry electrically connected to the resistance heater, the switch, and the receiving coil; and
a counter with a countertop having a top surface and a bottom surface, a magnet, a power source, a driving coil magnetically coupled with the receiving coil, a second switch within the countertop having a first position and a second position wherein the power source supplies power to the driving coil when the switch is in the first position, and driver circuitry connected to the driving coil;
wherein the position of the beverage coaster in relation to the counter determines whether the first switch is in the first position or second position and whether the second switch is in the first position or second position.
